(19) United States
(12) Patent Application Publication
(10) Pub. No.: US 2010/0097307 A1
(43) Pub. Date: Apr. 22, 2010

(54) METHOD AND SYSTEM OF REDUCING IMAGE STICKING

(75) Inventor: Chih-Chiang Chen, Taipei (TW)

Correspondence Address: WPAT, PC;INTELLECTUAL PROPERTY ATTORNEYS, 7225 BEVERLY ST., ANNANDALE, VA, 22003, US

(73) Assignee: ACER INCORPORATED, Taipei (TW)

(21) Appl. No.: 12/395,153

(22) Filed: Feb. 27, 2009

(30) Foreign Application Priority Data
Oct. 21, 2008 (TW) 097140332

(51) Int. Cl. G09G 3/36

(52) U.S. Cl. 345/89

(57) ABSTRACT

To reduce the image sticking, a first number of frames outputted from the multimedia signal source are successively received. The first number of frames are processed to obtain a plurality of corresponding gray-level characteristic. A predefined frame is inserted into a plurality of incoming frame with a specified ratio if the plurality gray-level characteristic is qualified to a specified predefined condition.

### FIELD OF THE INVENTION

The present invention relates to a method and a system of reducing the image sticking, and more particularly to a method and a system of reducing the image sticking resulted from a liquid crystal display (LCD).

### BACKGROUND OF THE INVENTION

FIG. 1 depicts a functional block diagram illustrating a LCD system. Conventionally, the LCD system includes an analog-to-digital converter (ADC) 102, a scaler 104, a timing controller (TCON) 122, a driving circuit 124, and a LCD panel 126. The ADC 102 and the scaler 104 together constitute an image processing unit 10. Furthermore, the TCON 122, the driving circuit 124, and the LCD panel 126 together constitute a LCD panel module 12.

The ADC 12 is used for receiving an analog frame, and then converting the analog frame into a digital frame; where the analog frame can be outputted from a multimedia device, such as a computer, a television set, or a media player (not shown). Because the resolution of the LCD panel 126 is fixed before released to the market but the resolution of the received frame is various, the pixels in the received frame must be zoom-in or zoom-out first by the scaler 104 to make the size, the light intensity, and the color of the frame to fit the specification of the LCD panel 126. Afterwards, the modified pixels of the received frame are then outputted to the TCON 122. The TCON 122 is used to modify the sequence and the timing of showing the pixels of the received frame. The driving circuit 124 then outputs the driving voltages to the LCD panel 126 according to the pixels of the received frame. Then, the corresponding image of the received frame can be shown by the LCD panel 126 via modifying the arrangement of the liquid-crystal molecules in the LCD panel 126 according to the received driving voltages.

FIG. 2 is a scheme illustrating an internal structure of the LCD panel 126. The LCD panel 126 includes a polarizer 1262, a glass substrate 1264, an indium tin oxide (ITO) film 1266, an alignment film 1268, a color filter 1270, a thin film transistor (TFT) 1272, and a plurality of liquid-crystal molecule 1274. The driving voltages, derived from the driving circuit 124 depicted in FIG. 1 and for the driving of the liquid-crystal molecule 1274, are outputted to the TFT 1272 and the ITO 1266. The alignment film 1268 is used for fixing the liquid-crystal molecule 1274 to a specific direction. The color filter 1270 is used for filtering the light 14 to red, green, blue lights that are named as a RGB, where the light 14 is emitted from a back-light source (not shown). The polarizer 1262 is used for guaranteeing all the lights in the LCD panel 126 are outputting to or incoming from a specific direction.

The driving of the LCD panel 126 is based on the optical activity of the liquid-crystal molecule 1274. When the driving voltages, derived from the TFT 1272 and the ITO 1266, are applied to the liquid-crystal molecule 1274, the liquid-crystal molecule 1274 is accordingly rotated to a corresponding angle, so as partial of the light 14 can emit through the liquid-crystal molecule 1274 and partial of the light 14 cannot emit through the liquid-crystal molecule 1274. In other words, via controlling the value of the driving voltages applied to the liquid-crystal molecule 1274, the amount (or light intensity) of the light 14 capable of emitting through the liquid-crystal molecule 1274 is accordingly controlled. Also, the light intensity of the light 14 capable of emitting through the liquid-crystal molecule 1274 is named as a gray level.

Basically, the LCD can be categorized to a normal-white LCD or a normal-black LCD based on the corresponding angle of the liquid-crystal molecule 1274 after the LCD panel is applied by the driving voltages. The LCD panel 126 is categorized to a normal-white LCD, such as the twisted nematic (TN) LCD, if the light 14 can be fully emitted through the liquid-crystal molecule 1274 applied with zero driving voltage, so as the image shown by the normal-white LCD panel 126 has a highest light intensity. Accordingly, the image shown by the normal-white LCD panel 126 has a lowest light intensity if the normal-white LCD panel 126 is applied by a highest driving voltage. That is to say, the light intensity of the image shown by the normal-white LCD is related to the value of the driving voltage. On the other hand, the LCD panel 126 is categorized to a normal-black LCD, such as the in-plane switching (IPS) LCD or the multi-domain vertical alignment (MVA) LCD, if no light 14 can be emitted through the liquid-crystal molecule 1274 applied with highest driving voltages, so as the image shown by the normal-black LCD panel 126 has a lowest light intensity. Accordingly, the image shown by the normal-black LCD panel 126 has a highest light intensity if the normal-black LCD panel 126 is applied by zero driving voltage. That is to say, the light intensity of the image shown by the normal-black LCD panel is related to the value of the driving voltage.

An internal electric field, so as an internal electric capacity, is generated after the two glass substrates 1264 located on the two ends of the LCD panel 126 adsorbing the charged ions in the liquid-crystal molecule 1274 when the driving voltages are applied to the LCD panel 126 for a relatively long period. Once the charged ions cannot be released from the internal electric capacity when the LCD panel 126 shows a next image, so as the liquid-crystal molecule 1274 cannot be rotated to a specified angle corresponding to the image, the image sticking is resulted in.

The image sticking can be illustrated by the FIGS. 3A and 3B. FIG. 3A is a scheme illustrating a LCD showing an image with a plurality of black block 301. If the LCD suddenly turns to show a white image after a long-term showing the image depicted in FIG. 3A, the image-sticking block 303 depicted in FIG. 3B is resulted in. The image-sticking block 303 has a lower gray level compared to the black block 301.

Please refer to FIG. 2 again. Not only the image sticking is resulted in when the liquid-crystal molecule 1274 is applied under a relatively high driving voltage, the quality of the image shown by the LCD panel 126 or the life of LCD panel 126 may be also reduced. Because the ion or the impurity are also appeared in the liquid-crystal molecule 1274 and the alignment film 1268, the residual DC voltage is accordingly increased if the liquid-crystal molecule 1274 is applied under a relatively high driving voltage, so as the quality of the image shown by the LCD panel 126 and the life of LCD panel 126 is reduced.

Conventionally, the screen saver is introduced in the LCD system to avoid the image sticking. If an image is shown on a LCD panel for a relatively long period, the execution of the screen saver can prevent the LCD panel to be operated under a relatively high driving voltage. In other words, via the execution of the screen saver, the frame inputted to the LCD panel is changed. Accordingly the intensity of the driving voltage applied to the LCD panel is changed. However, once the screen saver is performed, the user cannot operate the multimedia device, such as the computer, the television set, or the media player, via the LCD panel.

### SUMMARY OF THE INVENTION

Therefore, the present invention provides a method and a system of reducing the image sticking without performing the screen saver, and the user can still operate the multimedia device via the LCD panel.

The present invention relates to a method of reducing image sticking, applied between a liquid crystal display system and a multimedia signal source, comprising steps of: successively receiving a first number of frames outputted from the multimedia signal source; correspondingly computing a plurality of gray-level characteristic according to a RGB of a plurality of pixel in the received frames; and inserting a predefined frame into a plurality of incoming frame with a first ratio and then outputting the inserted frame if the plurality of gray-level characteristic is qualified to a first predefined condition.

The present invention relates to a liquid crystal display system with a function of reducing image sticking, comprising: a scaler for successively receiving a plurality of digital frame, and outputting the plurality of digital frame after modifying the light intensity and the color of a plurality of pixel in the plurality of digital frame; and a liquid crystal display panel connected to the scaler, for showing a plurality of corresponding image according to the plurality of digital frame; wherein the scaler further comprises a gray-level extraction and analysis unit, for correspondingly computing a plurality of gray-level characteristic according to a RGB of a plurality of pixel in the plurality of received digital frames, and notifying the scaler to insert a predefined frame into a plurality of incoming digital frame with a first ratio and then outputting the predefined frames if the plurality of gray-level characteristic is qualified to a predefined condition.

The present invention relates to a liquid crystal display system with a function of reducing image sticking, comprising: a timing controller for successively receiving a plurality of digital frame, and outputting the plurality of digital frame after modifying the sequence and the timing of a plurality of pixel in the plurality of digital frame; and a liquid crystal display panel connected to the timing controller, for showing a plurality of corresponding image according to the plurality of digital frame; wherein the timing controller further comprises a gray-level extraction and analysis unit, for correspondingly computing a plurality of gray-level characteristic according to a RGB of the plurality of pixel in the plurality of received digital frames, and notifying the timing controller to insert a predefined frame into a plurality of incoming digital frame with a first ratio and then outputting the predefined frames if the plurality of gray-level characteristic is qualified to a predefined condition.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a functional block diagram illustrating a conventional LCD system;

FIG. 2 is a scheme illustrating an internal structure of the LCD panel;

FIG. 3A is a scheme illustrating a LCD showing an image with a plurality of black block;

FIG. 3B is a scheme illustrating the image sticking is resulted in after a long-term period showing the image depicted in FIG. 3A;

FIG. 4A is a histogram illustrating a gray-level distribution of a frame;

FIG. 4B is another histogram illustrating a gray-level distribution of a frame;

FIG. 5A is a flowchart illustrating the present invention of the method of reducing the image sticking;

FIG. 5B is a scheme illustrating an example of inserting a mid-gray frame to a plurality of normal frame based on the weight of the high-gray levels to the whole gray levels;

FIG. 5C is another flowchart illustrating the present invention of the method of reducing the image sticking;

FIG. 5D is another flowchart illustrating the present invention of the method of reducing the image sticking; and

FIGS. 6A and 6B are functional block diagrams illustrating the present invention of a system of reducing the image sticking.

### DETAILED DESCRIPTION OF PREFERRED EMBODIMENTS

Each frame is constructed by pixels with different value of RGB. That is to say, the pixel (0, 0, 0), also defined as a zero-gray level, has a lowest light intensity; contrarily, the pixel (255, 255, 255), also defined as a 255-gray level, has a highest light intensity. Therefore, each frame can be regarded as constructed by many gray levels, and each gray level is in the range from the zero-gray level to the 255-gray level. Besides, for the convenience, the gray level having a relatively low value is defined as a low-gray level (having a relatively low light intensity); contrarily, the gray level having a relatively high value is defined as a high-gray level (having a relatively high light intensity) in the embodiment of the present invention.

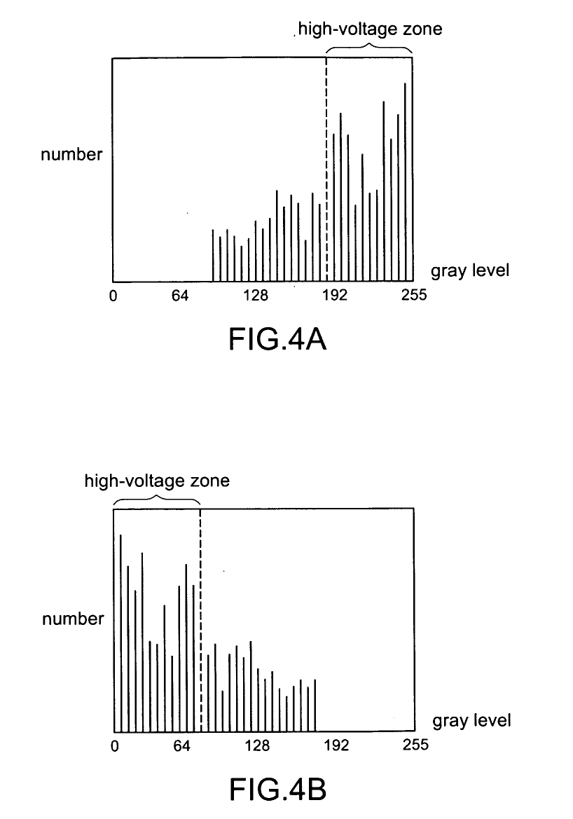

FIG. 4A depicts a histogram illustrating a gray-level distribution of a frame, and the frame is assumed to be shown by a normal-black LCD. As described above, a relatively high driving voltage must be applied to the normal-black LCD to show a high-gray level (high light intensity). In other words, the driving voltage is increasing with the increasing value of the gray level in a normal-black LCD. Therefore, the gray levels with values greater than a specified value (e.g., 192-gray level) can be regarded as operated in a high-voltage zone, as depicted in FIG. 4A. Contrarily, FIG. 4B depicts a histogram illustrating a gray-level distribution of another frame, and the frame is assumed to be shown by a normal-white LCD. As described above, a relatively high driving voltage must be applied to the normal-white LCD to show a low-gray level (low light intensity). In other words, the driving voltage is decreasing with the decreasing value of the gray level in a normal-white LCD. Therefore, the gray levels with values less than a specified value (e.g., 64-gray level) can be regarded as operated in a high-voltage zone, as depicted in FIG. 4B.

A gray-level extraction and analysis, for calculating the gray-level distribution of a received frame, is implemented in the present invention. If a first number of gray-levels in a received frame is determined in the high-voltage zone and the first number is greater then a specified number, the received frame is regard as a high-voltage frame. According to the present invention, when a number of the high voltage frames received by the LCD is greater then a predetermined frame count, a mid-gray frame will be inserted into the incoming frame for reducing the image sticking.

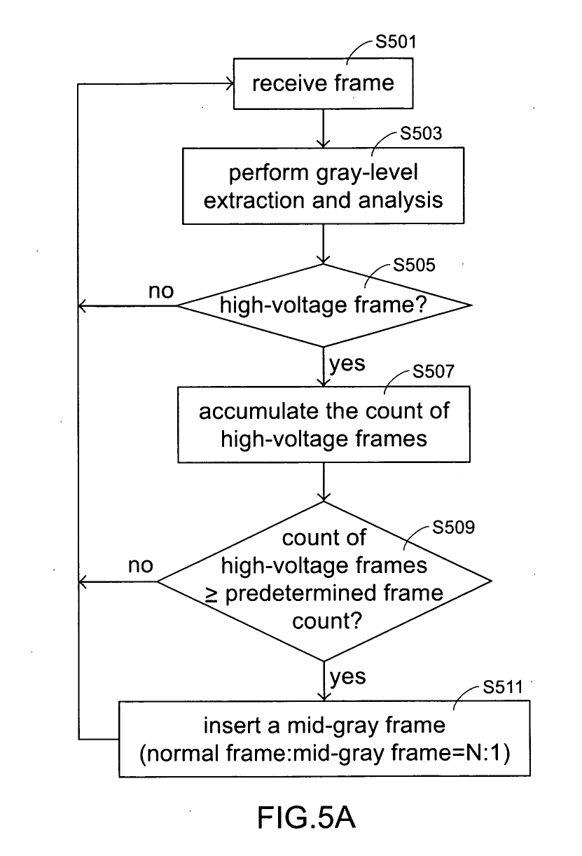

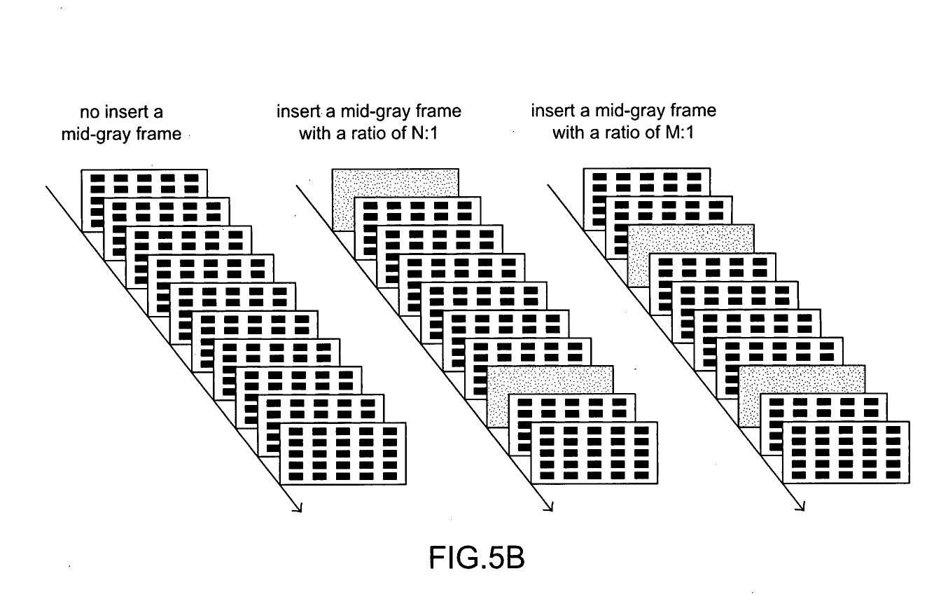

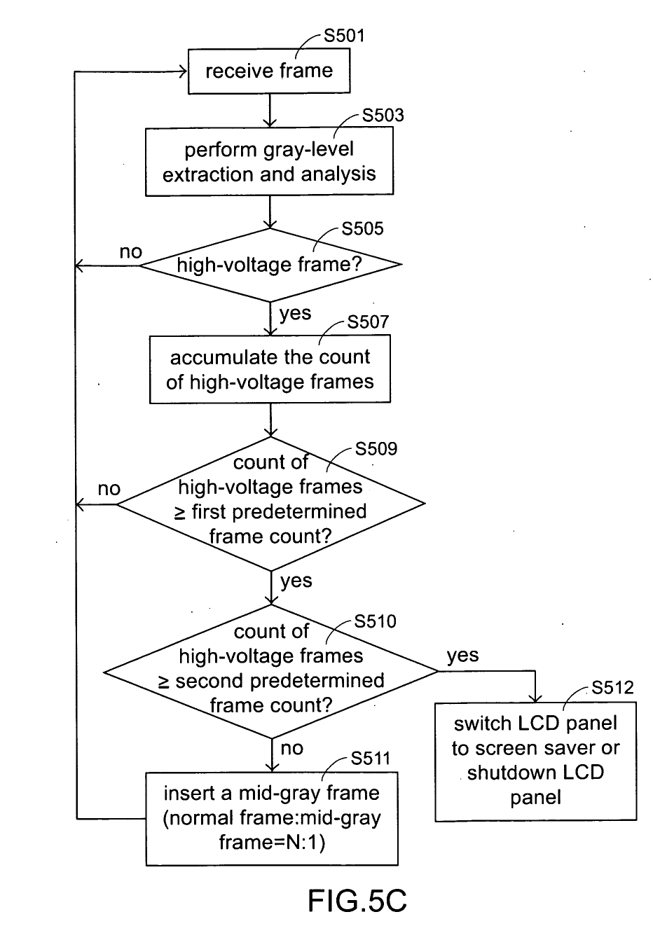

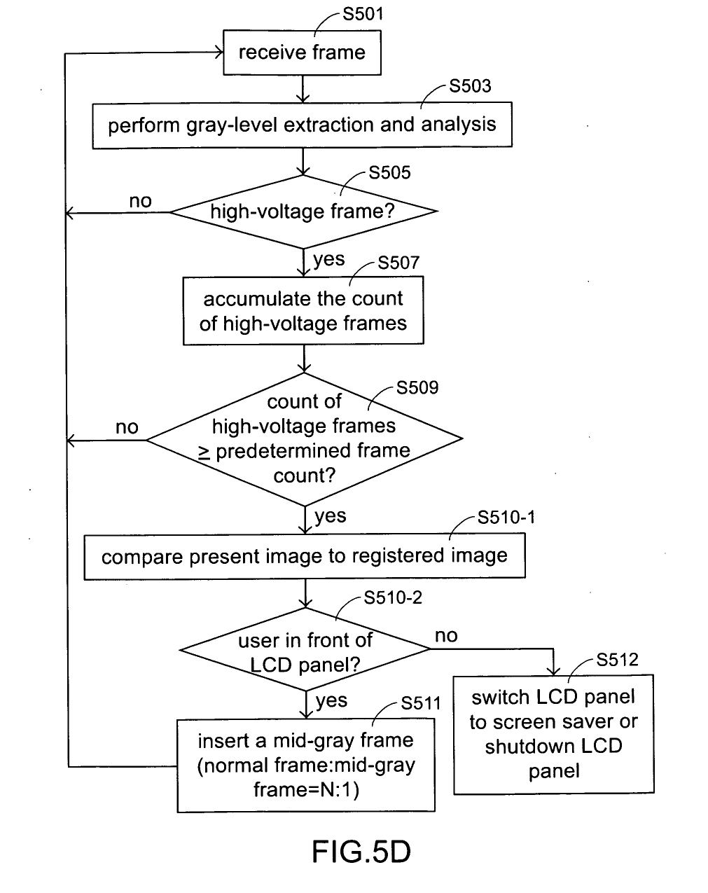

FIG. 5A is a flowchart illustrating the present invention of the method of reducing the image sticking. First, the method of the present invention receives a frame (step S501) outputted from a multimedia device (e.g., computers, television sets, or media players). After the gray-level extraction and analysis of the received frame is performed (step S503), the gray-level distribution of the received frame is obtained. If the ratio of the high-gray levels (e.g., above 192-gray level) to the whole gray levels of the received frame is over a specified ratio (e.g., 70%) and the frame is shown by a normal-black LCD, accordingly the frame is defined as a high-voltage frame. Similarly, if the ratio of the low-gray levels (e.g., below 64-gray level) to the whole gray levels of the received frame is over a specified ratio (e.g., 70%) and the frame is shown by a normal-white LCD, accordingly the frame is defined as a high-voltage frame.

If the received frame is not a high-voltage frame based on the result of the gray-level extraction and analysis, the method of the present invention moves to the step of receiving the next incoming frame (step S501). On the other hand, accumulate the count of the high-voltage frames (step S507) if the received frame is a high-voltage frame (step S505). If the high-voltage frames are continuously sent from the multimedia device but the accumulating count of the received high-voltage frames is not over a predetermined frame count (step S509), the method of the present invention moves to the step of receiving the next incoming frame (step S501). However, if the accumulating count of the received high-voltage frames is over the predetermined frame count (step S509), the image sticking may happen and a mid-gray frame is inserted into the incoming frames with a ratio of N:1 (step S511). The mid-gray frame is constructed by pixels with middle values of RGB, and the mid-gray frame accordingly can be shown by a LCD panel applied by a driving voltage ranged between a relatively high driving voltage and a relatively low driving voltage. Also, the ratio of N:1 means that one mid-gray frame is inserted into every N received frames (normal frames). That is to say, once the method of the present invention determines the LCD panel is in the risk of occurring the image sticking, one mid-gray frame is inserted into the incoming N frames (N normal frames) outputted from the multimedia device, so as the image sticking can be avoid.

To a normal-black LCD, it is understood that inserting a low-gray frame into a plurality of high-gray frame can get a better performance to avoid image sticking. However, the inserted low-gray frame may also bring an obvious contrast between the relatively high and the relatively low light intensities, so as the quality of the outputting image is poor. Therefore, for the balance between the anti of the high driving voltage and the maintaining of the image quality, the mid-gray frame is considered in the embodiment of the present invention. Similarly, to a normal-white LCD, even inserting a high-gray frame into a plurality of low-gray frames can get a better performance to avoid image sticking, the mid-gray frame is still considered in the embodiment of the present invention.

Furthermore, in the present invention of the method of reducing image sticking (only the normal-black LCD is took for the example), the ratio of the normal frames to the mid-gray frame can be dynamically adjusted based on ratio of the weight of the high-gray levels to the whole gray levels of the received frame. For example, after the gray-level extraction and analysis is done to the received frame and calculating the ratio of the high-gray levels (e.g., above 192-gray level) to the whole gray levels in the frame is over to 70%, and this type of frames are continuously outputted from the multimedia device over a predetermined frame count, a mid-gray frame will be inserted into the incoming normal frames with a ratio of N:1. For example, every 50 incoming normal frames will be inserted with a mid-gray frame. On the other hand, after the gray-level extraction and analysis is done to the received frame and calculating the ratio of the high-gray levels (e.g., above 192-gray level) to the whole gray levels in the frame is over to 80%, and this type of frames are continuously outputted from the multimedia device over the predetermined frame count, a mid-gray frame will be inserted in the incoming normal frames with a ratio of M:1. For example, every 30 incoming normal frames will be inserted with a mid-gray frame. By using the dynamically adjustment of the ratio of the mid-gray frames to the normal frames, a better performance of anti the high electric field is obtained.

FIG. 5B depicts a scheme illustrating an example of inserting a mid-gray frame to a plurality of normal frame based on the weight of the high-gray levels to the whole gray levels. The left side of the FIG. 5B illustrates sequentially displaying a plurality of frame with many black blocks without adopting the present invention of the method of reducing the image sticking. If these frames are sequentially displayed by a LCD for a relatively long time, the LCD is in the risk of resulting in the image sticking. The middle side of the FIG. 5B illustrates sequentially displaying a plurality of frame with many black blocks by adopting the present invention of the method of reducing the image sticking; where the ratio of the high-gray levels (e.g., above 192-gray level) to the whole gray levels in each frame is over 70% and the ratio of the normal frames to the mid-gray frames is N:1. The right side of the FIG. 5B illustrates sequentially displaying a plurality of frame with many black blocks by adopting the present invention of the method of reducing the image sticking; where the ratio of the high-gray levels (e.g., above 192-gray level) to the whole gray levels in each frame is over 80%, and the ratio of the normal frames to the mid-gray frames is M:1.

Furthermore, the present invention of the method for reducing the image sticking can be adopted with the conventional screen saver or other monitor power saving mechanism. FIG. 5C is another flowchart illustrating the present invention of the method of reducing the image sticking. The steps before S509 are already described above in the flowchart depicted in FIG. 5A. If the accumulating count of the received high-voltage frames is not only over a first predetermined frame count (step S509) but also over a second predetermined frame count (step S510), then the method of the present invention assumes the LCD showing this type of frames over a reasonable period, accordingly, the LCD will be switched to the screen saver or the LCD will be directly shut down (step S512).

Furthermore, the present invention of the method of reducing the image sticking can be adopted with image-capture devices such as the CCD camera. The image-capture device is used for detecting whether the user is appeared in front of the LCD or not, and whether inserting the mid-gray frame is based on the detected result. FIG. 5D is another flowchart illustrating the present invention of the method of reducing the image sticking. The steps before S509 are already described above in the flowchart depicted in FIG. 5A. If the accumulating count of the received high-voltage frames is over a predetermined frame count (step S509), a present image captured by the image-capture device is compared with another image of the user in front of the LCD (step S510-1). If the comparing result indicates the user is in front of the LCD (step S510-2), then the method of the present invention inserts the mid-gray frame into the plurality of incoming normal frame with a ratio of N:1 (step S511). On the other hand, if no user is detected in front of the LCD, the LCD will be switched to the screen saver or the LCD will be directly shut down (step S512) due to no need to insert the mid-gray frame for reducing the image sticking.

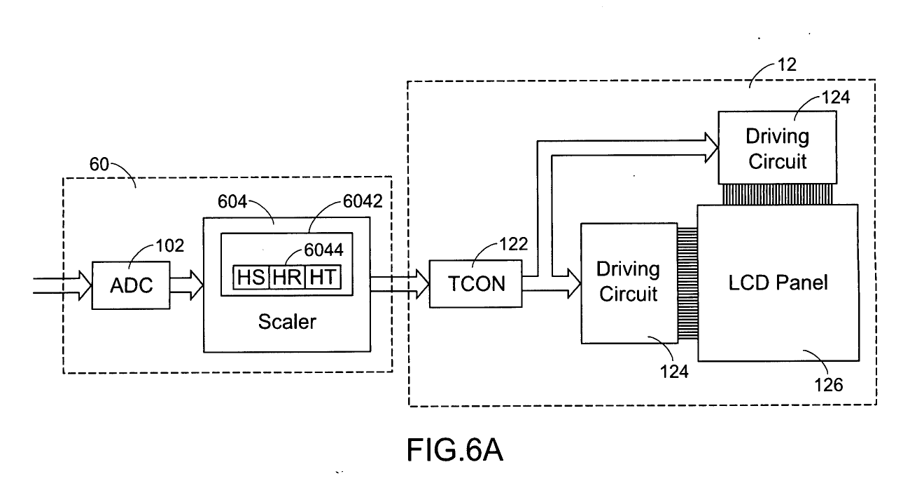

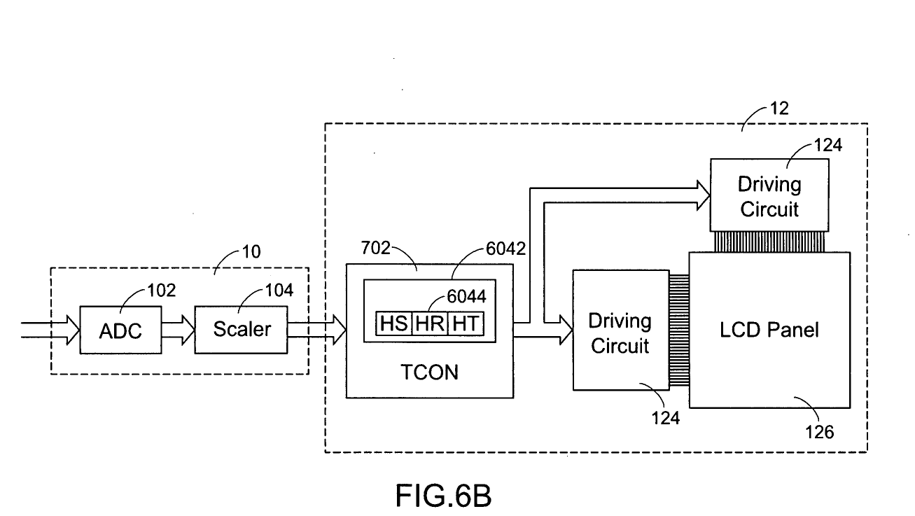

The above-described gray-level extraction and analysis and the determination of inserting the mid-gray frame can be implemented by a gray-level extraction and analysis unit. As described above, the scaler in the LCD system can output a gray frame via the controlling of the light intensity and the color of the outputting image, it is reasonable to integrate the gray-level extraction and analysis unit of the present invention into the scaler. FIG. 6A is a functional block diagram illustrating the present invention of a system of reducing the image sticking (only the normal-black LCD is took as an example). The system includes an ADC 102, a scaler 604, a TCON 122, a driving circuit 124, and a LCD panel 126. The scaler 604 further includes a gray-level extraction and analysis unit 6042. In the gray-level extraction and analysis unit 6042, a high-gray level standard value (HS), a high-gray ratio standard value (HR), and an insert-mid-gray-frame count (HT) are predefined. Also, the high-gray level standard value (HS), the high-gray ratio standard value (HR), and the insert-mid-gray-frame count (HT) can be stored in a register 6044 of the gray-level extraction and analysis unit 6042.

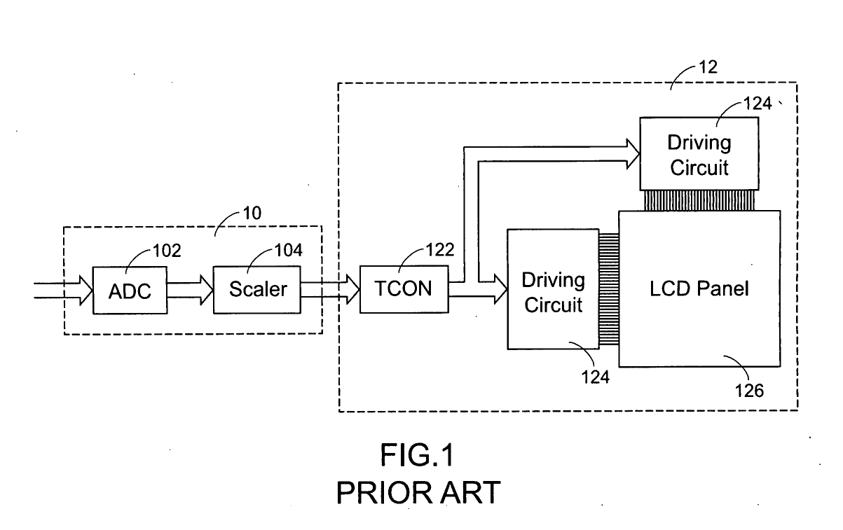

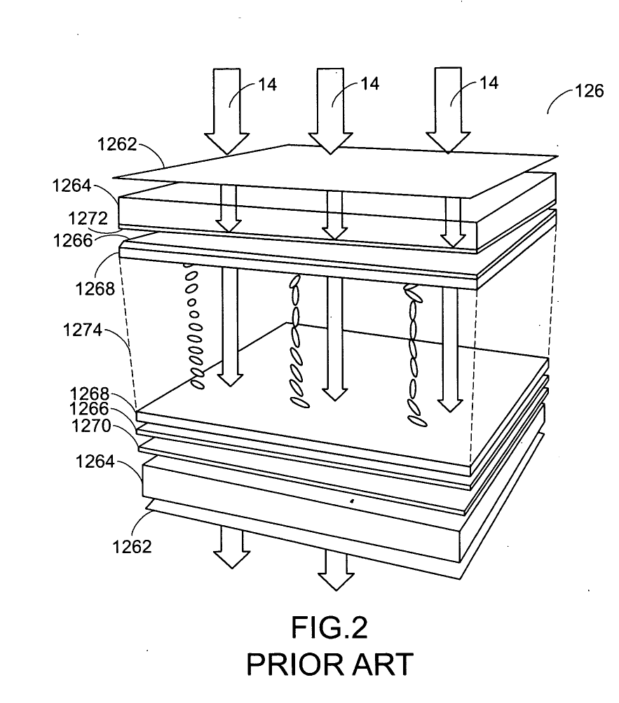

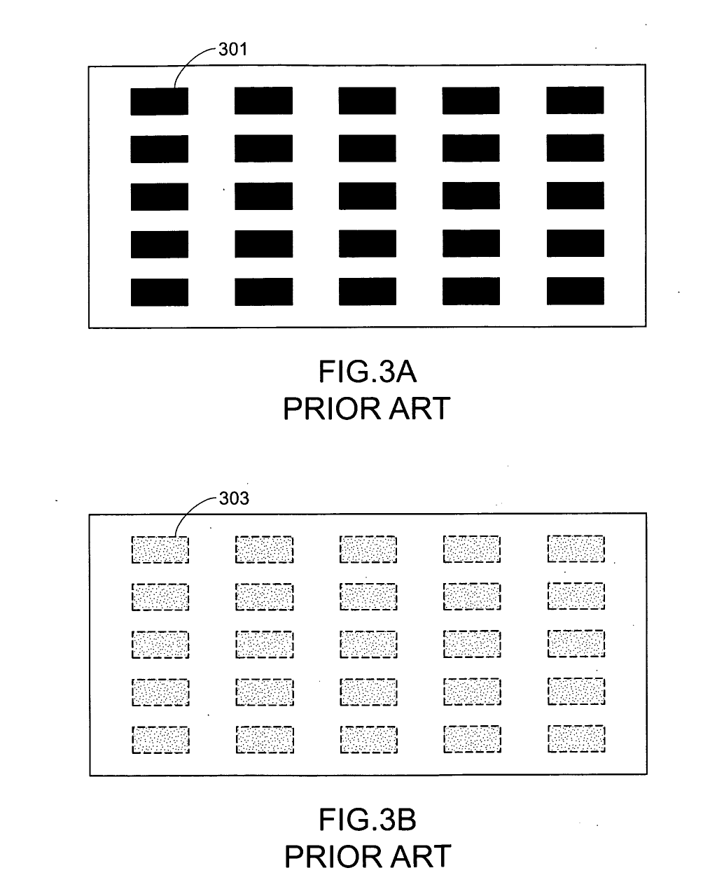

First, a frame is outputted from the multimedia device (e.g., computers, television sets, or media players) to the scaler 604 via the ADC 12. After the gray-level extraction and analysis is done to the received frame by the gray-level extraction and analysis 6042, the gray-level distribution of the received frame is obtained. Afterwards, the computed gray-level distribution of the received frame is compared to the high-gray level standard value (HS) and the high-gray ratio standard value (HR) stored in the register 6044. If the ratio of some specified gray levels equal/or greater than the high-gray level standard value (HS, e.g., 192) to the whole gray levels of the frame is over the high-gray ratio standard value (HR, e.g., 70%), the received frame is defined as a high-voltage frame, and a counter (not shown) adds the count of the high-voltage frames by one. If the high-voltage frames are continuously sent from the multimedia device and the accumulating count of the received high-voltage frames is up to the insert-mid-gray-frame count (HT), a mid-gray frame is inserted into the incoming frames with a ratio of N:1 by the scaler 604. In other words, via the scaler 604 capable of controlling the light intensive and the color of the received frame, the gray-level extraction and analysis 6042 can inform the scaler 604 to insert a gray frame after every receiving N normal frames if the accumulating count of the received high-voltage frames is up to the insert-mid-gray-frame count (HT). Afterwards, the inserted gray frame is sent to the TCON 122. Because the functions of the ADC 102, the TCON 122, the driving circuit 124, the LCD panel 126 already explained in FIG. 1, no further describing of the above devices here.

Furthermore, the TCON in the LCD system can output a gray frame via the controlling of the sequence and the timing of the outputting pixels; it is reasonable to integrate the gray-level extraction and analysis unit of the present invention into the TCON. FIG. 6B is another functional block diagram illustrating the present invention of a system of reducing the image sticking. Because the only difference to the system depicted in FIG. 6A is that inserting the gray frame is performed by the TCON 122, no further describing of other devices here.

To sum up, according to the present invention, once the LCD is in the risk of occurring the image sticking, a mid-gray frame is inserted into the incoming frames to anti the high electric field, so as the image sticking can be avoid. Furthermore, because the anti of the image sticking is not via the screen saver, the user still can operate the multimedia device (e.g., computers, television sets, or media players) via the LCD.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of reducing image sticking, applied between a liquid crystal display system and a multimedia signal source, comprising steps of:
successively receiving a first number of frames outputted from the multimedia signal source;
correspondingly calculating a plurality of gray-level characteristic according to a RGB of a plurality of pixel in the received frames; and
inserting a predefined frame into a plurality of incoming frame with a first ratio and then outputting the inserted frame if the plurality of gray-level characteristic is qualified to a first predefined condition.

2. The method of reducing image sticking according to claim 1, wherein the first predefined condition is based on a ratio of the high-gray levels to the whole gray levels in the plurality of received frame is above a first specified number if the liquid crystal display system is a normal-black liquid crystal display system; or the first predefined condition is based on a ratio of the low-gray levels to the whole gray levels in the plurality of received frame is above a first specified number if the liquid crystal display system is a normal-white liquid crystal display system.

3. The method of reducing image sticking according to claim 1, further comprising a step of continuously receiving a plurality of frames outputted from the multimedia signal source if the plurality of gray-level characteristic is not qualified to the first predefined condition.

4. The method of reducing image sticking according to claim 1, wherein the predefined frame is constructed by a plurality of pixel with a middle value of RGB.

5. The method of reducing image sticking according to claim 1, further comprising a step of successively receiving a second number of frames outputted from the multimedia signal source, and performing a screen saver to the liquid crystal display system or shutting down the liquid crystal display system if the plurality of related gray-level characteristic is qualified to the first predefined condition, wherein the second number is greater than the first number.

6. The method of reducing image sticking according to claim 1, wherein the execution of the method of for reducing image sticking is determined by a user or automatically executed if the user is detected not in front of the liquid crystal display system.

7. The method of reducing image sticking according to claim 1, further comprising a step of inserting the predefined frame into a plurality of incoming frame with a second ratio and then outputting the inserted frame if the plurality of gray-level characteristic is qualified to a second predefined condition.

8. The method of reducing image sticking according to claim 7, wherein the second predefined condition is based on a ratio of the high-gray levels to the whole gray levels in the plurality of received frame is above a second specified number if the liquid crystal display system is a normal-black liquid crystal display system, or, the second predefined condition is based on a ratio of the low-gray levels to the whole gray levels in the plurality of received frame is above a second specified number if the liquid crystal display system is a normal-white liquid crystal display system; and the second specified number is greater than the first specified number, the second ratio is less than the first ratio.

9. A liquid crystal display system with a function of reducing image sticking, comprising:
a scaler for successively receiving a plurality of digital frame, and outputting the plurality of digital frame after modifying the light intensity and the color of a plurality of pixel in the plurality of digital frame; and
a liquid crystal display panel connected to the scaler, for showing a plurality of related image according to the plurality of digital frame;
wherein the scaler further comprises a gray-level extraction and analysis unit, for correspondingly computing a plurality of gray-level characteristic according to a RGB of a plurality of pixel in the plurality of received digital frames, and notifying the scaler to insert a predefined frame into a plurality of incoming digital frame with a first ratio and then outputting the predefined frames if the plurality of gray-level characteristic is qualified to a predefined condition.

10. The liquid crystal display system with a function of reducing image sticking according to claim 9, further comprising
an analog-to-digital converter,
a timing controller, and
a driving circuit, wherein
the analog-to-digital converter, connected between a multimedia device and the scaler, is used for
receiving a plurality of analog frame outputted from the multimedia device,
converting the plurality of analog frame to a plurality of digital frame, and
outputting the plurality of digital frame to the scaler;
the timing controller and the driving circuit are sequentially connected between
the scaler and the liquid crystal display panel, the timing controller is used for receiving the plurality of digital frame outputted from the scaler, and outputting the plurality of digital frame after modifying the sequence
and the timing of a plurality of pixel in the plurality of digital frame;
the driving circuit is used for
receiving the plurality of digital frame outputted from the timing controller,
resulting in a plurality of driving voltage according to the plurality of received digital frame, and
outputting the plurality of driving voltage to the liquid crystal display panel; the liquid crystal display panel can show the plurality of image according to the plurality of driving voltage.

11. The liquid crystal display system with a function of reducing image sticking according to claim 9, wherein the predefined condition is based on a ratio of the high-gray levels to the whole gray levels in the plurality of digital frame is above a specified number if the liquid crystal display system is a normal-black liquid crystal display system; or the predefined condition is based on a ratio of the low-gray levels to the whole gray levels in the plurality of digital frame is above a specified number if the liquid crystal display system is a normal-white liquid crystal display system.

12. The liquid crystal display system with a function of reducing image sticking according to claim 10, wherein the analog-to-digital converter continuously receives a plurality of analog frames from the multimedia device if the plurality of gray-level characteristic is not qualified to the predefined condition.

13. The liquid crystal display system with a function of reducing image sticking according to claim 9, wherein the predefined frame is a digital frame constructed by a plurality of pixel with a middle value of RGB.

14. The liquid crystal display system with a function of reducing image sticking according to claim 10, wherein the multimedia device is a computer, a television set, or a media player.

15. A liquid crystal display system with a function of reducing image sticking, comprising:
a timing controller for successively receiving a plurality of digital frame, and outputting the plurality of digital frame after modifying the sequence and the timing of a plurality of pixel in the plurality of digital frame; and
a liquid crystal display panel connected to the timing controller, for showing a plurality of related image according to the plurality of digital frame;
wherein the timing controller further comprises a gray-level extraction and analysis unit, for correspondingly computing a plurality of gray-level characteristic according to a RGB of the plurality of pixel in the plurality of received digital frames, and notifying the timing controller to insert a predefined frame into a plurality of incoming digital frame with a first ratio and then outputting the predefined frames if the plurality of gray-level characteristic is qualified to a predefined condition.

16. The liquid crystal display system with a function of reducing image sticking according to claim 15, further comprising
an analog-to-digital converter,
a scaler, and a driving circuit, wherein the analog-to-digital and the scaler are sequentially connected between a multimedia device and the timing controller;
the analog-to-digital converter is used for
receiving a plurality of analog frame outputted from the multimedia device,
converting the plurality of analog frame to the plurality of digital frame, and
outputting the plurality of digital frame to the scaler;
the scaler is used for
receiving the plurality of digital frame outputted from the analog-to-digital converter, and
outputting the plurality of digital frame after modifying the light intensity and the color of a plurality of pixel in the plurality of digital frame;
the driving circuit, connected between the timing controller and the liquid crystal display panel, is used for
receiving the plurality of digital frame outputted from the timing controller,
resulting in a plurality of driving voltage according to the plurality of received digital frame, and
outputting the plurality of driving voltage to the liquid crystal display panel;
the liquid crystal display can show the plurality of image according to the plurality of driving voltage.

17. The liquid crystal display system with a function of reducing image sticking according to claim 15, wherein the predefined condition is based on a ratio of the high-gray levels to the whole gray levels in the plurality of digital frame is above a specified number if the liquid crystal display system is a normal-black liquid crystal display system; or the predefined condition is based on a ratio of the low-gray levels to the whole gray levels in the plurality of digital frame is above a specified number if the liquid crystal display system is a normal-white liquid crystal display system.

18. The liquid crystal display system with a function of reducing image sticking according to claim 16, wherein the analog-to-digital converter continuously receives a plurality of analog frames from the multimedia device if the plurality of gray-level characteristic is not qualified to the predefined condition.

19. The liquid crystal display system with a function of reducing image sticking according to claim 15, wherein the predefined frame is a digital frame constructed by a plurality of pixel with a middle value of RGB.

20. The liquid crystal display system with a function of reducing image sticking according to claim 16, wherein the multimedia device is a computer, a television set, or a media player.
